(19) United States
(12) Patent Application Publication
(10) Pub. No.: US 2023/0289518 A1
(43) Pub. Date: Sep. 14, 2023

(54) System and Methods for Rendering and Manipulating Pivot Tables

(71) Applicant: Zoho Corporation Private Limited, Kanchipuram District (IN)

(72) Inventors: Forcia Grace D, Urappakkam (IN); Kirubhakaran Mohan, Kattankulathur (IN); Anjana Venkatachalam, Medavakkam (IN); Punithavathi Palani, Chennai (IN)

(73) Assignee: Zoho Corporation Private Limited, Kanchipuram District (IN)

(21) Appl. No.: 18/112,738

(22) Filed: Feb. 22, 2023

Related U.S. Application Data
(60) Provisional application No. 63/332,780, filed on Apr. 20, 2022.

(30) Foreign Application Priority Data
Mar. 8, 2022 (IN) 202241012522

(51) Int. Cl. G06F 40/18; G06F 3/0485; G06F 3/04815

(52) U.S. Cl. CPC G06F 40/18; G06F 3/0485; G06F 3/04815

(57) ABSTRACT

Described are systems and methods for rendering a three-dimensional (3D) pivot table that can be embedded in a spreadsheet. A data structure underlying the 3D pivot table contains raw data organized in arrays that can be depicted as two-dimensional (2D) tables. A rendering system combines some or all of the 2D tables into a 3D rendering of a pivot table in which each of the combined sides represents a visible face of the 3D pivot table. A user can split the rendered 3D pivot table along one or three axes to expose internal data elements for viewing or editing. Changes to the values of internal data elements impact values presented in the visible faces of the 3D pivot table.

### CROSS REFERENCE TO RELATED APPLICATIONS

This application claims priority to U.S. Provisional Application Ser. No. 63/332,780 to Forcia Grace D et al., filed 20 Apr. 2022, which is incorporated herein by reference.

### BACKGROUND

Data visualization programs, such as spreadsheets, include analysis tools to create “pivot tables,” which are tables of grouped values that aggregate items of more extensive tables. A pivot table can be used to summarize, sort, group, count, total, or average data stored in a table. Pivot tables allow users to group fields, transform rows to columns, and vice versa. This interactive tool allows users to view data from different perspectives and extract important data from large data sets.

### SUMMARY

Detailed are methods and system for rendering and manipulating three-dimensional (3D) pivot tables for data analysis and visualization. A two-dimensional (2D) pivot table is used to capture multi-dimensional data. A pivoting engine process the data structure underlying the 2D pivot table to render the data as a multifaced 3D pivot table in which each face depicts rows and columns of cell values derived from the data. A graphical user interface (GUI) controls access to the underlying data structure to allow the user to access and manipulate the rendered cell values, and to split the 3D pivot table to access and manipulate interior cell values that are not visible in the initial 3D rendering.

### BRIEF DESCRIPTION OF DRAWINGS

FIG. 1 is an overall architectural diagram for a 3D pivot-table rendering system 100.

FIG. 2 depicts a user interface 200 for a spreadsheet application that supports a 3D pivot table.

FIG. 3 is a flowchart 300 illustrating a 3D pivoting algorithm in accordance with one embodiment.

FIG. 4 illustrates a pivot table 400 constructed based on user-selected fields.

FIG. 5 is a 2D table 500 relating data values for year and region in pivot table 400 of FIG. 4.

FIG. 6 is a 2D table 600 relating data values for product and year in pivot table 400 of FIG. 4.

FIG. 7 is a 2D table 700 relating data values for product and region in pivot table 400 of FIG. 4.

FIG. 8 depicts a rectangular prism 800, a data structure rendering with tables 500, 600, and 700 on the three visible, exterior faces.

FIG. 9 is a 2D table 900 showing product/region cell values for year 2013, an unrendered interior XZ slice of prism 800.

FIG. 10 depicts a flow diagram 1000 illustrating a slicing operation for a prism in accordance with one embodiment.

FIG. 11A depicts prism 800 of FIG. 8 with a user's finger 1100 selecting a row of the rendered XY face providing total sales by region for the year 2013.

FIG. 11B illustrates prism 800 divided into first and second data-structure slices 800A and 800B to expose sales by product and region for the year 2013, the data introduced in FIG. 9 and selected in FIG. 11A.

FIG. 11C is similar to FIG. 11B, illustrating prism 800 of FIG. 8 divided into slices 800A and 800B.

FIG. 11D illustrates slices 800A and 800B with the cell highlighted in FIG. 11C changed from six to nine to update the number of sales of Product C that took place in Region 2 for 2013.

FIG. 12 depicts prism 800 of FIG. 8 sliced to highlight sales by region and year for a product Product C.

FIG. 13 depicts prism 800 of FIG. 8 sliced to highlight sales by product and year for a region Region 1.

FIG. 14 depicts a prism 1400 that illustrates how a 3D pivot table can support 3D scrolling.

FIG. 15 is a flowchart 1500 illustrating scrolling action through data organized in a prism arrangement.

### DETAILED DESCRIPTION

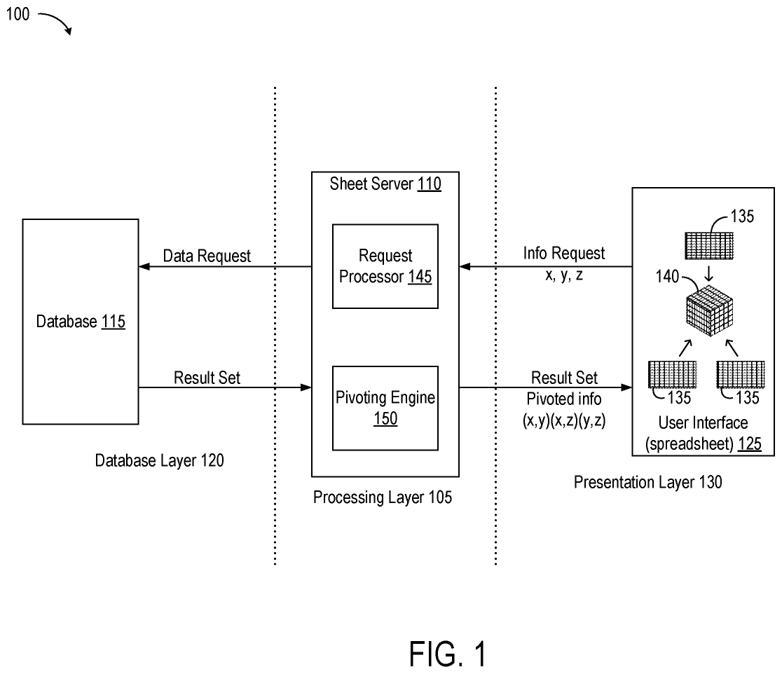

FIG. 1 is an overall architectural diagram for a 3D pivot-table rendering system 100. The system comprises a processing layer 105 with a sheet server 110 coupled to a database 115 in a database layer 120 and a user interface 125 in a presentation layer 130. User interface 125 serves a spreadsheet application that operates on data entered in data cells of two-dimensional (2d) tables 135, which presentation layer 130 can combine and render as faces of a 3D pivot table 140. Each cell in tables 135 may contain either numeric or text data, including the results of formulas that automatically calculate and display a value based on the contents of other data cells in pivot table 140. Pivot table 140 is “cuboid” in this example. “Cuboid” expresses a sense in which the depicted spreadsheet object appears to have six sides, three of which are visible when rendered in two dimensions. The sides need not be square. The data structure presentation layer 125 renders as pivot table 140 includes unrendered interior faces (not shown) that the user can access and edit by cleaving the cuboid along one of three axes. Cells in the unrendered interior surfaces can, like those of the exterior surface, have values that are functions of cells in one or more interior or exterior surfaces.

The implementation of the 3D pivot rendering system is not limited to a spreadsheet application. It can also be implemented on data analytics/visualization systems. Sheet server 110 includes a request processor 145 to request raw data from database 115 and a pivoting engine 150 to construct 3D pivot table 140 in the spreadsheet application under control of user interface 125. Responsive to user input, interface 125 issues sheet server 110 an information request for values corresponding to user-selected dimensions—say X, Y, and Z—for building a 3D pivot table. Request processor 145 requests the values from raw data in database 115. A result set, the obtained values from the raw data, are delivered to pivoting engine 150, which ties the values of a field from raw data in the spreadsheet application, with each dimension X, Y, and Z to construct a 3D pivot table. Tables 135 represent the result set used to construct pivot table 140 but need not be rendered. Pivoting engine 150 can generate 2D tables 135 from the result set. A front-end tool in presentation layer 130 convenes them and renders the information as a 3D object, e.g. a cuboid or more generally a prism (including a rectangular prism). Each 2D table 135 constitutes a face of the 3D object, and some or all these faces can be visible when the 3D object is visualized in an isometric view.

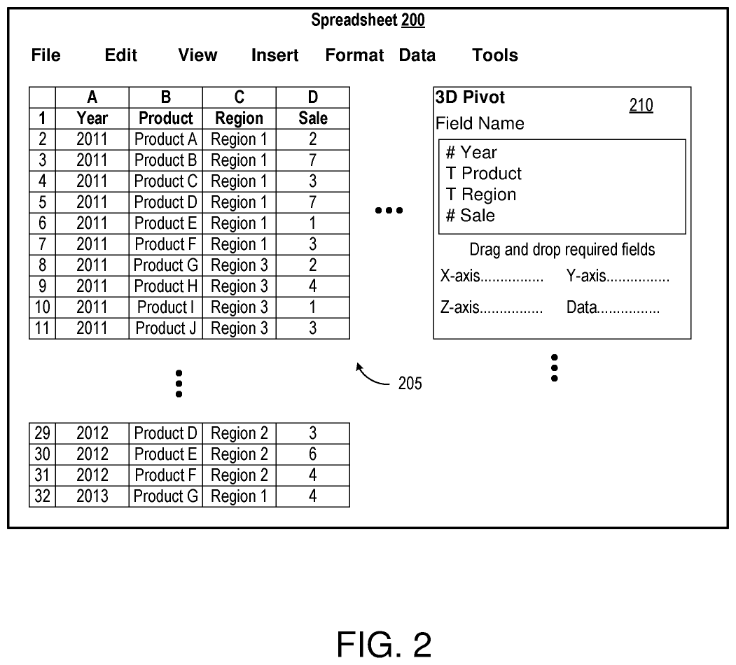

FIG. 2 depicts a user interface 200 for a spreadsheet application that supports a 3D pivot table. The 3D pivot builder displays a pivot table field list 205 comprising fields or columns from the raw data in the spreadsheet application. A user can drag any field, like year, product, region, sale, etc., from pivot table field list 205 and drop it into a dimension field in a 3D-pivot-builder regions 210 specifying one of three dimensions X, Y, and Z axes. A prism is responsively generated and rendered as an embedded object a spreadsheet.

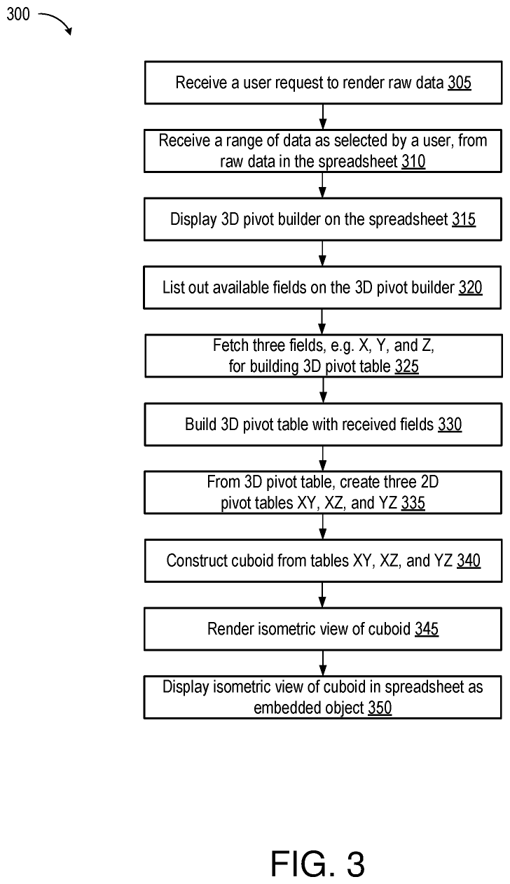

FIG. 3 is a flowchart 300 illustrating a 3D pivoting algorithm in accordance with one embodiment. A user initiates a request to render the raw data in a spreadsheet (step 305), prompting sheet server 110 to request the raw data. Presentation layer 130 receives the requested data and employs it to build field list 205. The user can then select a range or ranges of data from list 205 for presentation in 3D (step 310). This selection can prompt or be preceded by the user selecting a 3D pivot builder, prompting the presentation of 3D-pivot-builder region 210 (315). The user pulls data from list 205 into region 210 (320). If there is more than one field in the pivot table field list, then the order can be rearranged by allowing the user to drag each field and drop it into a precise dimension as required by the user.

The three fields selected by user are considered as three dimensions of the 3D pivot table. The values of the three fields (e.g. fields X, Y, and Z) are fetched from the raw data in the spreadsheet (325) and used to build a 3D pivot table (330). Three 2D tables are then created from the 3D pivot table (335). Among the three 2D tables, a XY table holds values corresponding to the dimensions X and Y, a YZ table that holds values corresponding to the dimensions Y and Z, and an XZ table holds values corresponding to the dimensions Z and X. With these 2D tables, a cuboid (e.g. prism 140 of FIG. 1) is constructed (340), the cuboid having a first face Face 1 containing 2D Table 1 (e.g., the XY table); a second face Face 2 containing 2D Table 2 (e.g., the YZ table); and a third face Face 3 containing 2D Table 3 (e.g., the XZ table). An isometric view of the prism is rendered (345) so that these three faces of the prism are visible to the user. The prism is displayed as an embedded object in a new spreadsheet (350), or in the same spreadsheet as required by the user.

Any update operations made in the raw data thereafter are automatically reflected on 3D pivot table 140. Update operations include removing/deselecting one or more rows, adding one or more rows, and amending values of raw data in the spreadsheet. Removing/de-selecting one or more rows in the raw data of the spreadsheet causes a corresponding reduction in the prism dimension size in proportion to number of removed rows. Similarly, adding one or more rows to the raw data causes a corresponding increase in prism dimension size in proportion to number of added rows. Amending one or more values in raw data updates the 3D pivot table and then the amended value is reflected on the prism. Amending the values in the raw data need not affect the size of the prism dimension.

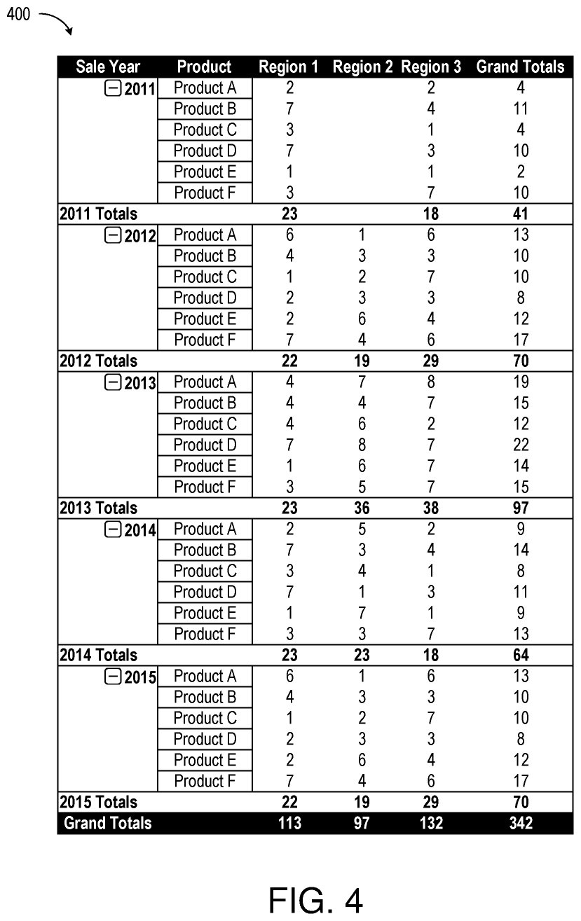

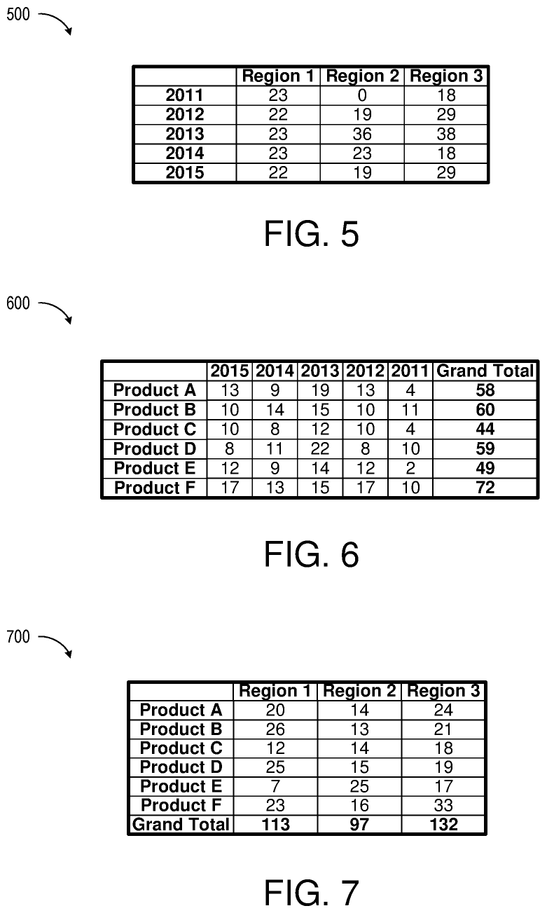

FIG. 4 illustrates a pivot table 400 constructed based on user-selected fields. The user wishes to construct a 3D pivot table from these data. The three dimensions in this scenario are Region, Year, and Product. Three 2D tables are created from pivot table 400 as shown in FIGS. 5, 6, and 7.

FIG. 5 is a 2D table 500 relating data values for year and region in pivot table 400 of FIG. 4.

FIG. 6 is a 2D table 600 relating data values for product and year in pivot table 400 of FIG. 4.

FIG. 7 is a 2D table 700 relating data values for product and region in pivot table 400 of FIG. 4.

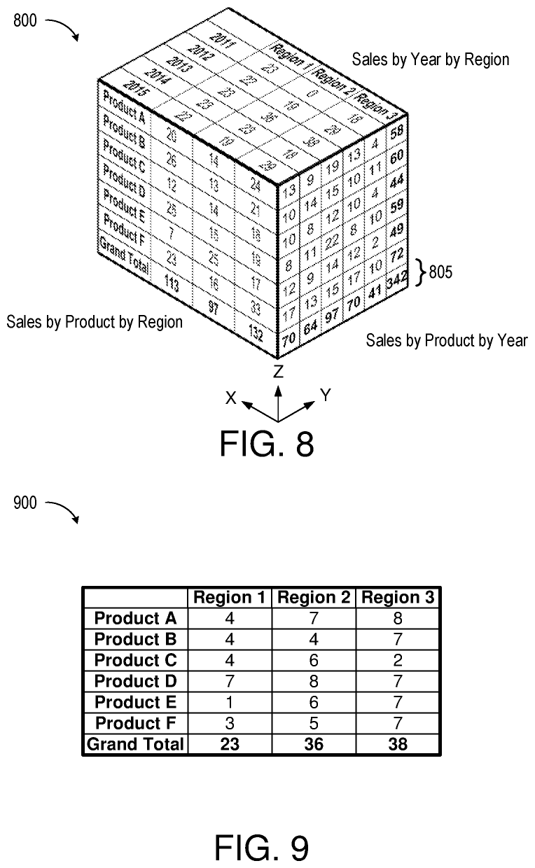

FIG. 8 depicts a rectangular prism 800, a pivot-table data structure rendering with tables 500, 600, and 700 on the three visible, exterior faces. Of the rendered, external faces of prism 800, the XY face has rows and columns of XY data cells, the value for each representing a number of sales in a given year and region; the XZ face has rows and columns of XZ data cells, the value for each representing a number of sales of a given product across all regions; and the YZ face has rows and columns of YZ data cells, the value for each representing a number of sales of a product in a year. Each XZ cell in the bottom row sums the values of the respective column, all product sales in a given region. For the YZ face, each YZ cell in the bottom row sums the values in the respective column, all products sold in a given year; and in the rightmost row the sum of the values in the respective row, all sales of a respective product. The value of the lower right YZ cell 805 provides total sales, the sum of the corresponding column, the corresponding row, or the grand totals from the lowest row of the XZ face.

Prism 800 provides an intuitive view of the sales data from multiple perspectives. The data structure underlying prism 800 has more to offer, however, data that can be conceptualized as unrendered interior faces of prism 800. FIG. 9, for example, is a 2D table 900 showing product/region cell values for year 2013, an unrendered interior XZ slice of prism 800. The data structure rendered as prism 800 maintains data and functions that relate interior cell values to cell values of the rendered faces. Users can slice prism 800 to view these interior data. 3D renderings other than prisms can be used.

i. Slicing Operation on the Prism:

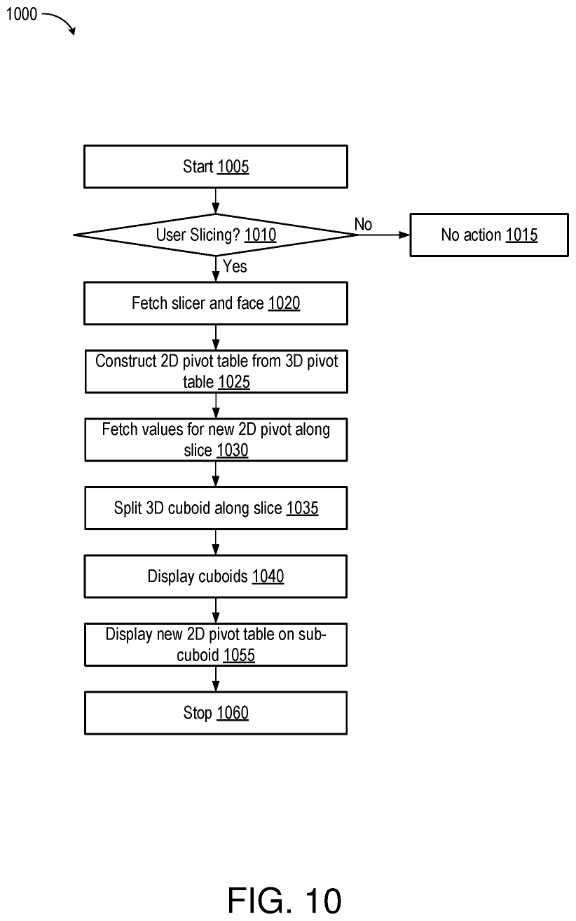

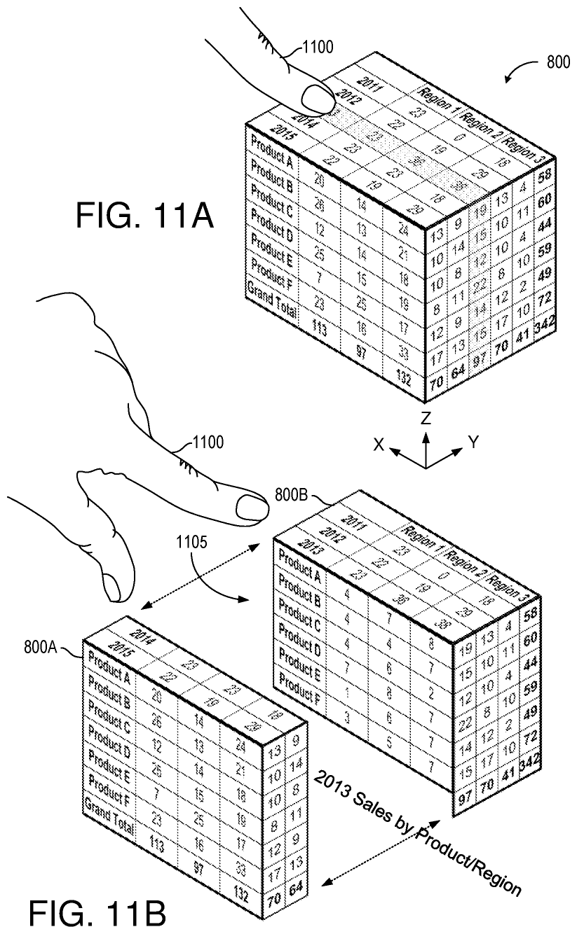

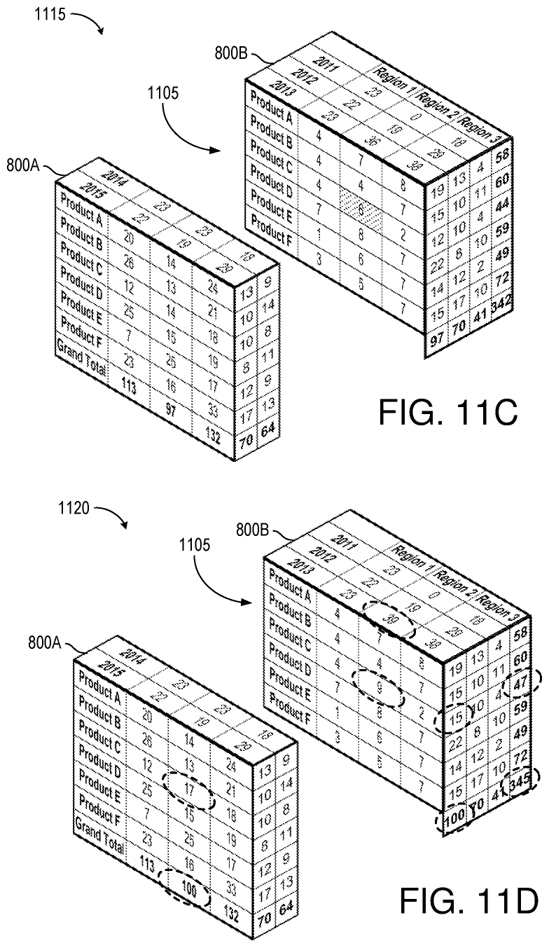

Prism 800 can be sliced along any plane extending there through to expose an interior face with rows and columns of values. For example, slicing prism 800 in the XZ plane between years 2013 and 2014 gives table 900, or the data thereof, and this information is used to render a new prism with table 900 as a visible face. Processes for so splitting prism 800 are detailed below in connection with FIGS. 10 and 11.

FIG. 10 depicts a flow diagram 1000 illustrating a slicing operation for a prism in accordance with one embodiment. The process begins with a rendered 3D pivot table like prism 800 (1005). Per decision 1010, no action is taken (1015) unless the user initiates slicing by e.g. double tapping along any field on any face of the prism as required. In other embodiments, invisible, unrendered cell values that require computation are calculated in advance of slicing.

If the user initiates a slice operation, a 3D slicer is created for the selected unrendered face (1020) and a 2D pivot table is constructed from the data structure (1025) used to render the 3D pivot table. The values for the 2D pivot table are extracted or calculated from the data structure (1030). The cuboid is split along the selected slice (1035) and displayed as two cuboids, or slices, in an exploded manner (1040) on the existing spreadsheet. One of the slices displays the values on one side of the divide and the other slice the values on the other side of the divide. The 2D table exposed by the slicing operation is rendered as a face of one of the cuboids (1055) and the slicing operation is complete (1060).

FIG. 11A depicts prism 800 of FIG. 8 with a user's finger 1100 selecting a row of the rendered XY face providing total sales by region for the year 2013. The user might make this selection to gain access to 2013 sales numbers broken down by product and region. The selected slice is highlighted by shading.

FIG. 11B illustrates prism 800 divided into first and second data-structure slices 800A and 800B to expose what had been an unrendered XZ face, sales by product and region for the year 2013, the data introduced in FIG. 9 and selected in FIG. 11A. The pivot table supports an interface function that allows the user to slice and reaggregate prism 800 using e.g. pinch gestures. The separation between slices 800A and 800B makes each cell of the newly exposed XY face 1105 visible. For larger data sets, a portion of the interior surface may be obscured, and both interior and exterior faces can be made to scroll. In slice 800B, each XY cell in the row for year 2013 sums the values of the respective column of the XZ face, and each YZ cell in the first column sums the values of the respective row of the XZ face. Using the example of the three-faceted corner cuboid of slice 808B, the XY data cell has a value 36 that is the sum of the rightmost column of the newly exposed XZ face 1105, sales for all products in Region 3 for 2013; and the YZ data cell has a value 19 that is the sum of the uppermost row of XY face 1105, sales for Product A across all regions for 2013.

ii. Updating Data Values on the Prism:

FIG. 11C is similar to FIG. 11B, illustrating prism 800 of FIG. 8 divided into slices 800A and 800B. In this instance, however, a cell of value six in exposed interior face 1105 is highlighted by shading to indicate that a user has selected this cell for editing (e.g. by tapping on the data value). Data values rendered on the exterior faces are functions of interior values so editing the highlighted cell impacts other cells.

FIG. 11D illustrates slices 800A and 800B with the cell highlighted in FIG. 11C changed from six to nine to update the number of sales of Product C that took place in Region 2 for 2013. Other data cells updated by this change are highlighted, each increased by three relative to their corresponding cells in the example of FIG. 11C to reflect the edit.

One embodiment supports edits of the type illustrated in FIGS. 11C and 11D without the separate slicing operation of FIG. 11B. Instead, and with reference to FIG. 11A, selecting the 2013 Region 2 cell value 36 for edit automatically splits prism 800 in the manner of FIG. 11B and highlights the values for 2013, Region 2, the column of values that contribute to the selected cell of value 36 on the XY face. Changes to one or more values of 2013 Region 2 are propagated to update affected values of slices 800A and 800B.

In some embodiments, a dialog (not shown) opens when the user inputs the gesture to modify a data value. The dialogue displays the value or values from the raw data that constitute the to-be-modified data value on the prism. The user can select a particular value from the raw data displayed in the dialogue. The user is then directed to the cell containing the same value of the raw data, in the spreadsheet. Now the user can modify the value in the cell as required. The 3D pivot table is updated with the modification, and the pivoted information too gets updated. Finally, the modification is reflected on the prism corresponding to the updates in the pivoted information extracted from the 3D pivot table. An updated version of prism 800 can then be reformed by e.g. pinching slices 800A and 800B back together.

In addition to taking the user to the particular cell in the spreadsheet, the following method can also be employed to modify a data value on the prism. When the user inputs the gesture to modify a data value on the prism, a dialogue opens to display the values from the raw data that constitute the to-be-modified data value on the prism. The user can select one of the values to be modified from the dialogue. A second dialogue comes up to get a new value instead of the selected value. The raw data in the spreadsheet is automatically updated with the new value in the second dialogue. The 3D pivot table and the pivoted information are updated. Finally, the modification is reflected on the prism corresponding to the updates in the pivoted information extracted from the 3D pivot table.

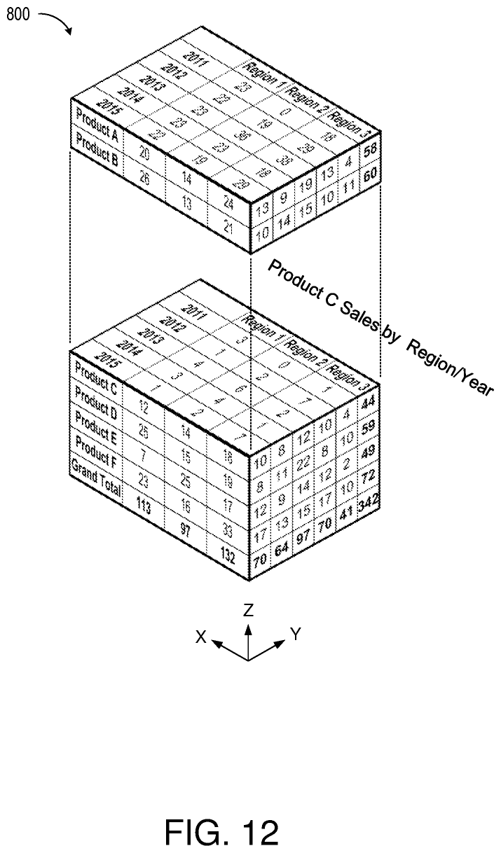

FIG. 12 depicts prism 800 of FIG. 8 sliced to highlight sales by region and year for a product Product C.

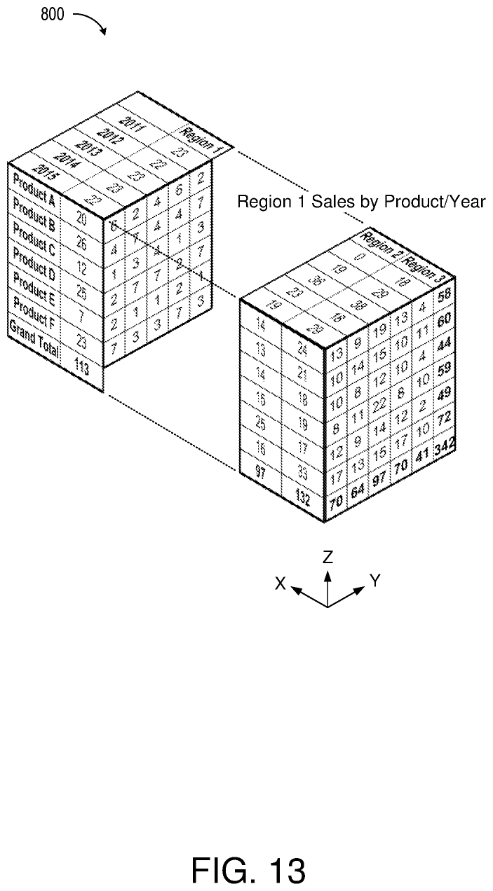

FIG. 13 depicts prism 800 of FIG. 8 sliced to highlight sales by product and year for a region Region 1.

iii. Scrolling Operation on the Prism

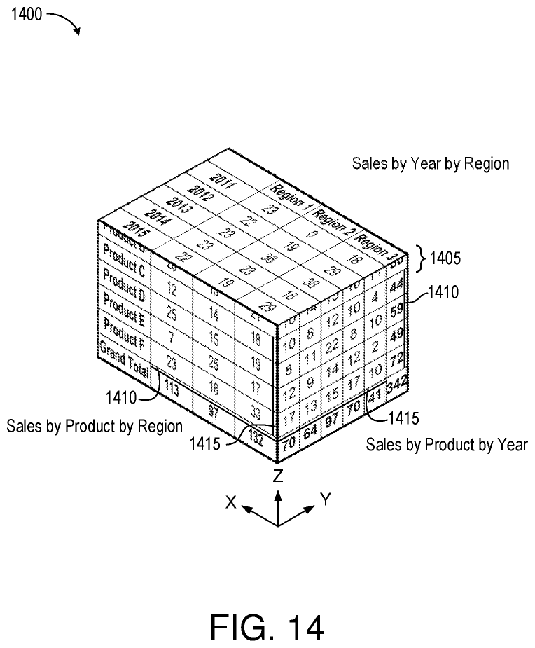

FIG. 14 depicts a prism 1400 that illustrates how a 3D pivot table can support 3D scrolling. The user can scroll a table by panning on the faces of a prism. The faces will be scrolled along the axis of user's pan action. The user can lock the headers, such that the tabular data will be scrolled with headers fixed. In this example, the top slice 1405 is partially obscured to illustrate an upward (along the Z axis) scrolling of cells on the XZ and YZ faces. The values depicted on the XY face are sums of all seen and unseen values but can be different in other settings or embodiments (e.g., they can sum the visible or a selected subset of logically related cells).

Scroll operations accommodate more content in the prism and facilitate navigation on all faces. Scroll operations support horizontal scrolling, vertical scrolling, and diagonal scrolling. When the user performs horizontal scrolling on a first face of the prism, the columns on a second face of the prism scroll corresponding to the columns of the first face. For example, a user-interface element 1410, a slider, facilitates horizontal scrolling along the X dimension on the XZ face. Manipulating this slider scrolls the values of both the XZ and XY faces along the X dimension. The rows and columns depicting grand total values and/or row headers of the XZ and XY faces are frozen. As an addition or alternative to slider 1410, a user can scroll horizontally by selecting a cell and dragging it left or right along the X axis.

When the user performs vertical scrolling on a first face of the prism, the rows on a second face of the prism scroll corresponding to the rows of the first face. For example, manipulating a vertical slider 1415 along the Z dimension on the XZ face scrolls the values on both the XZ and YZ faces along the Z dimension; grand total values and/or column headers of the XZ and YZ faces are frozen. When the user performs diagonal scrolling on a first face of the prism, the rows and columns on the other two faces likewise scroll while the grand total values and/or headers are frozen. For diagonal scrolling on the XZ face, the user can select e.g. the upper left cell (Product C, Region 1) and drag it lower and to the right. All three faces can support horizontal, vertical, and diagonal scrolling such that the user can navigate to all the rows and columns of the prism.

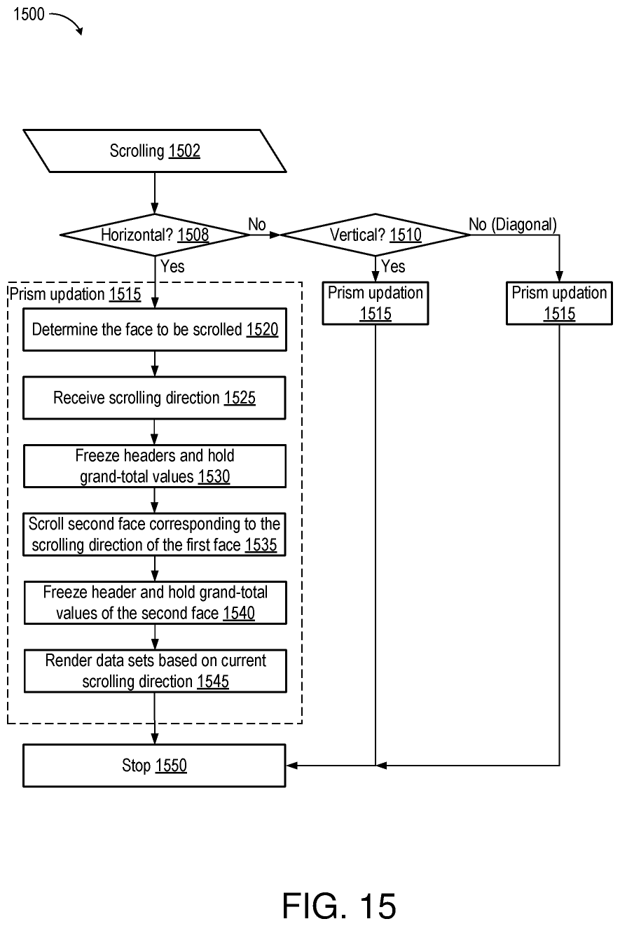

FIG. 15 is a flowchart 1500 illustrating scrolling action through data organized in a prism arrangement as detailed above. Flowchart 1500 references a cuboid, but other 3D shapes can be used. A face of the prism become scrollable if the data represented thereon exceeds the available area. When an axis on a face is scrolled, the corresponding face with the same axis is likewise scrolled.

The process starts when a user initiates scrolling via the user interface (1502). Per decisions 1508 and 1510, the presentation layer determines whether the scrolling is horizontal, vertical, or diagonal. If the requested scrolling is horizontal, then a prism updation process 1515 is employed to alter the prism as directed by the user input.

To update the prism responsive to a request for horizontal scrolling from the user interface, the presentation layer determines from the request which face or faces of the prism are to be scrolled (1520) and in which direction (1525), e.g. face XZ to the left or right. The presentation layer freezes the headers arranged orthogonal to the scroll direction, the Product row headings in this example, and maintains the grand total values (1530).

Scrolling one face effects at least one additional face. In the next step of prism updation 1515, the presentation layer scrolls the second face in a manner the corresponds to the scrolling of the first face (1535). The presentation layer freezes the headers on the second face that are arranged orthogonal to the scroll direction, the year row headings of the XZ face in this example (1540). Finally, scrolling operations are rendered for display (1545) and the scrolling process stops (1550) pending additional scrolling requests.

Requests for vertical or diagonal scrolling, once detected, are treated to prism updation processes 1515 that are the same or similar to that for horizontal scrolling. Diagonal scrolling applied to any of the three faces updates all three faces. While not shown, prisms divided into two or more slices can also be scrolled. Each slice or different collections of slices can be scrolled.

iv. Tilting the Prism

Users can tilt the 3D pivot table and change the positions of each axis. This helps the user change the “primary” face of the 3D rendering whenever required. All the slicing, scrolling, and tilting actions can be performed on any device like mobile phone, tablet, laptops, etc.

v. Previewing the Prism

The 3D data can be visualized in a preview mode too. The user can rotate the 3D rendering (e.g. the prism) by tiling their devices. The angle from a gyroscope attached to the display device is predicted. The 3D rendering is rotated in a corresponding direction.

vi. Inserting Comments on a Prism

Some embodiments provide a commenting functionality for team members when a spreadsheet is in collaborative mode. On selecting the comment icon from the options, users can add comments at specific data values on any face on the 3D data rendering. A comment will be positioned on the 3D rendering in the orientation at which the user added it. If a team member adds a comment, for example, the comment can be highlighted and visible to all the team members and the team can review the comment history. When the spreadsheet is in the collaborative mode, one or more users can add multiple comments on the 3D data. Comments added by user will be visible as a markup, and when markup is clicked the comment box is displayed. A reply option button is available for other users to add reply for the posted comment. Other embodiments are not collaborative or support non-collaborative modes in which a single user can add comments on the 3D rendering for later reference. A comment added at any specific data values from any face on the 3D data rendering can be displayed as a callout in the spreadsheet's margin.

vii. Panning and Zooming the Prism.

The prism can be panned in any direction and can be zoomed in and out.

viii. Dicing the Prism

Dicing allows users to pick specific values along multiple fields resulting in a slice. It is to break a data cube into smaller parts to view it from different points of view. In one embodiment, when the prism is diced an aggregate value of the data is also displayed.

ix. Locking the Prism During Collaboration or Sharing

While sharing or collaborating a prism with other users (who are collaborators too), by chance the other user(s) may change the prism layout by performing the operations of slicing, dicing, rotation, scrolling etc.

Some embodiments allow the owner of a document to lock the prism making it secure. A document owner can set permissions for who can access and edit the document, as well as what type of access and editing is allowed. A document owner can also set the permissions for the document to be shared with other users or groups. Permissions can be stored in a file system or database associated with the spreadsheet application. Depending on the system, they may also be stored in a separate permissions database or in an access control list. When the 3D Pivot builder is locked the data fields selected to represent each axis cannot be modified.

a. Enabling Lock Mode (to all Collaborators)

A document owner can set the permissions to lock the prism and forbid other operations by other collaborators of the spreadsheet document. All the collaborators can just view the prism with a layout that was displayed just before performing the locking action.

b. Enabling Lock Mode (to Selective Users Based on Hierarchy)

When lock mode is enabled (based on user hierarchy), users are selectively forbidden from performing operations on the prism such as slicing, dicing, rotation, scrolling etc., with respect to their hierarchy in an organization. The restrictions can be preset corresponding to each level in a user hierarchy.

x. Cloning Option for Other Collaborators in Lock Mode

In another embodiment, if a user (other than the owner) needs to access the prism in lock mode, first the user has to clone the prism. This cloned prism is embedded on a spreadsheet wherein the cloned prism is visible and is accessible by the user (who initiated the cloning process). Then the user can perform any operation like slicing, dicing, rotation, scrolling, etc. independently. When cloned prism is generated by any user other than owner, it can be viewed and stored independently into a spreadsheet which is not shared or collaborated.

xi. Converting Values of a Table on any Face of the Prism to a Graph or Chart, as Required by User.

While viewing the prism, if the user wishes to visualize the analytical insights of the values of a 2D table on any particular face of the prism, then the user can change that 2D table on the particular face of the prism into a chart or bar graph as required.

xii. Publishing the Prism:

The prism can be published with third party vendors, stakeholders etc. to visualize the insights of the data values in the prism. When published, the third-party vendors or stakeholders can perform operations like slicing, dicing etc. on the prism and view the data values. The third parties can be forbidden from accessing the raw data and the 3D Pivot builder. Variations of these embodiments, including embodiments in which features are used separately or in any combination, will be obvious to those of ordinary skill in the art. Therefore, the spirit and scope of the appended claims should not be limited to the foregoing description. In U.S. applications, only those claims specifically reciting “means for” or “step for” should be construed in the manner required under 35 U.S.C. § 112(f).

What is claimed is:

1. A computer-implemented method for presenting data, the method comprising:
rendering a data structure having an exterior XY face extending along an X axis and a Y axis and including rows and columns of XY data cells, an exterior XZ face extending along the X axis and a Z axis and including rows and columns of XZ data cells, and an exterior YZ face extending along the Y axis and the Z axis and including rows and columns of YZ data cells, wherein the data cells depict data elements and the data structure includes formulas that calculate values of at least some of the XY data cells as functions of the XZ data cells; and
receiving a slice command identifying two of the X, Y, and Z axes and, responsive to the slice command, slicing the data structure along the two of the X, Y, and Z axes and rendering the data structure as a first data-structure slice separated from a second data-structure slice.

2. The computer-implemented method of claim 1, wherein the two of the X, Y, and Z axes are the X and Z axes, the method further comprising:
rendering the first data-structure slice with the exterior XZ face and rendering the second data-structure slice with a second XZ face.

3. The computer-implemented method of claim 1, wherein the data cells depict data elements and the data structure includes formulas that calculate values of at least some of the XY data cells as functions of the YZ data cells.

4. The computer-implemented method of claim 2, wherein the second XZ face includes second XZ data cells.

5. The computer-implemented method of claim 4, the data structure including second formulas that calculate values of at least some of the second XZ data cells as a function of the XY data cells.

6. The computer-implemented method of claim 5, the data structure including third formulas that calculate values of at least some of the second XZ data cells as a function of the YZ data cells.

7. The computer-implemented method of claim 2, further comprising receiving an update command to change a value of one of the data cells on the XZ face and, responsive to the update command, calculating a new value for a data cell on the second XZ face and rendering the new value.

8. The computer-implemented method of claim 1, wherein the rendered data structure includes a corner cuboid with three of the data cells.

9. The computer-implemented method of claim 8, wherein the rendered first data-structure slice includes the corner cuboid and the second data-structure slice includes a second corner cuboid with a second three of the data cells.

10. The computer-implemented method of claim 1, wherein the XZ face includes XZ-total cells summing columns of the XZ data cells.

11. The computer-implemented method of claim 10, wherein the YZ face includes YZ-total cells summing columns of the YZ data cells.

12. The computer-implemented method of claim 11, wherein the YZ face includes second YZ-total cells summing rows of the YZ data cells.

13. The computer-implemented method of claim 1, further comprising receiving a lock command from an owner of the data structure and setting permissions for the data structure responsive to the lock command.

14. The computer-implemented method of claim 13, further comprising:
receiving a second command from a user of the data structure;
reviewing the permissions for the user of the data structure; and
ignoring the second command responsive to the permissions.

15. The computer-implemented method of claim 14, further comprising issuing an error message responsive to the permissions.

16. The computer-implemented method of claim 1, wherein at least one of the XY face, the XZ face, and the YZ face includes headers, the method further comprising:
receiving a scroll command selecting one of the XY face, the XZ face, and the YZ face with the headers; and
scrolling the data cells of the selected one of XY face, the XZ face, and the YZ face while freezing the headers.

17. The computer-implemented method of claim 1, wherein at least one of the XY face, the XZ face, and the YZ face includes cell totals, the method further comprising:
receiving a scroll command selecting one of the XY face, the XZ face, and the YZ face with the cell totals; and
scrolling the data cells of the selected one of XY face, the XZ face, and the YZ face while freezing the cell totals.

18. The computer-implemented method of claim 17, further comprising scrolling the data cells of the selected one of XY face, the XZ face, and the YZ face and the data cells of at least one other of the XY face, the XZ face, and the YZ face.

19. A pivot-table data structure rendered in X, Y, and Z dimensions, the data structure comprising:
a rendered XY face including rows and columns of rendered XY data cells;
a rendered XZ face including rows and columns of rendered XZ data cells, each rendered XZ cell in one of the rows of rendered XZ data cells depicting a sum of the other rendered XZ data cells in the corresponding column of rendered XZ data cells; and
a rendered YZ face including rows and columns of rendered YZ data cells.

20. The pivot-table data structure of claim 19, wherein the YZ face includes a row of YZ total cells, a column of YZ total cells, and a YZ grand-total cell summing the YZ total cells.

21. The pivot-table data structure of claim 19, each rendered YZ cell in one of the rows of rendered YZ data cells depicting a sum of the other rendered YZ data cells in the corresponding column of rendered YZ data cells.

22. The pivot-table data structure of claim 19, each rendered YZ cell in one of the columns of rendered YZ data cells depicting a sum of the other rendered YZ data cells in the corresponding row of rendered YZ data cells.

23. The pivot-table data structure of claim 19, further comprising functions that relate the rendered XY data cells to at least one of the rendered XZ data cells and the rendered YZ data cells.

24. The pivot-table data structure of claim 19, wherein the rendered XY face includes N of the rows of rendered XY data cells and M of the columns of rendered XY data cells, the data structure further comprising an unrendered XZ face including rows and columns of unrendered XZ data cells.

25. The pivot-table data structure of claim 24, each rendered XY cell in one of the rows of rendered XY data cells depicting a sum of one of the columns of the unrendered XZ data cells.

26. The pivot-table data structure of claim 24, further comprising an interface function to render the unrendered XZ face.

27. The pivot-table data structure of claim 26, wherein the interface function renders the unrendered XZ face as a cuboid depicting a first subset of the XY face and a subset of the YZ face.

28. The pivot-table data structure of claim 27, wherein the interface function divides the rendered XY face into the first subset of the XY face and a second subset of the XY face.
